(19) United States
(12) Patent Application Publication
(10) Pub. No.: US 2010/0023894 A1
(43) Pub. Date: Jan. 28, 2010

(54) SYSTEM FOR SELECTING ELEMENTS DISPLAYED ON A SCREEN

(75) Inventors: Pascal Le Mer, Perros Guirrec (FR); Emmanuel Pinot, Anjoutey (FR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: France Telecom, Paris (FR)

(21) Appl. No.: 12/520,155

(22) PCT Filed: Dec. 14, 2007
(86) PCT No.: PCT/FR07/52524

§ 371 Date: Jun. 19, 2009

(30) Foreign Application Priority Data
Dec. 20, 2006 (FR) 0655739

(51) Int. Cl. G06F 3/048

(52) U.S. Cl. 715/849

(57) ABSTRACT

System for selecting elements displayed on a screen, said elements (E₁, . . . , E_{N}) being arranged along a helix.

According to the invention, said helix (H) is represented in three dimensions on said screen, and said selection system comprises a pointing/selection device using a cursor (10) for pointing at/selecting any element to be selected on the helix and a device for manipulating the helix, able to modify at least locally the pitch of the helix.

Application to graphical interfaces.

The present invention relates to a system for selecting elements displayed on a screen.

The invention finds an advantageous application in the general field of graphical interfaces. It applies more especially to the field of user interactions with graphical interfaces, in particular when lists of data are particularly large in terms of number, such as digital photos, and pose miniaturization problems in respect of certain terminals, mobile telephones or PDAs for example, on account of their very small interaction areas.

In this context, the invention applies particularly to Collaborative Virtual Environments, which demand the display of a high density of data necessary for group collaboration, and, more generally, 3D Man/Machine Interfaces (MMIs).

Most graphical interfaces used at present are based on the manipulation of a list of elements by means of menus which represent a series of the elements in the plane of a screen. The interaction of a user with this list, namely for example the selecting of an element, or the deploying of sub-elements, is then done by virtue of a 2D cursor controlled by a peripheral of “mouse” or “trackball” type. When the number of elements of a menu becomes too large for them all to be represented on the screen, artifacts such as “scrollbars”, filters, based on date, size, alphabetical order, etc., or the use of an enlargement system, “zoom” or “magnifying glass”, on a miniaturized representation of the elements, nevertheless make it possible to access all these elements.

However, representation in the form of a 2D menu raises several difficulties.

The interaction area is often insufficient with respect to the number of data to be displayed so that a “flat” representation of the elements cannot afford the user an overall view of all the elements of the menu.

The remaining working area available on the screen may be substantially reduced due to the blanking out of the data of the application in progress by the deployed menus, even though transparency techniques make it possible to limit this drawback.

Finally, solutions using interactive elements (“widgets”), such as scrollbars, filters, etc., or data miniaturization, greatly impede fast interaction since they require numerous movements of the pointing peripheral: mouse, etc.

In order to allow the display of a larger quantity of data, other solutions use a third dimension supplementing the two dimensions of the screen. By way of example, it is possible to cite 2D menus displayed in perspective or else the system described in American patent application No. 2005/0044509 which consists in disposing all the elements of a list on a helix represented in 2D perspective on a screen and in unveiling a given fixed number, eight for example, of elements on a turn of the helix whose position is defined by the movement of a 2D sectional plane along the axis of the helix.

The main drawback of the system described in this American application is the access to a limited number, here eight, of elements of the manipulated list, since interaction is possible only with the elements of a single turn, access to other elements demanding the movement of the sectional plane defining the position of the operational turn. Moreover, a change of representation of the helix for a representation as a side view is necessary so as to move the sectional plane and bring it into the desired position. This results of course in a very appreciable slowdown in the speed of interaction.

Hence, an aim of the invention is to propose a system for selecting elements displayed on a screen, said elements being arranged along a helix, which would make it possible to display the entirety of the elements of a list, or menu, on an optimal area and to select an element without changing the mode of representation of the helix, therefore with a likewise optimal speed of interaction.

This aim is achieved, in accordance with the invention, on account of the fact that said helix is represented in three dimensions on said screen, and that said selection system comprises a pointing/selection device for pointing at/selecting any element to be selected on the helix and a device for manipulating the helix, able to modify at least locally the pitch of the helix.

Thus, through a representation in three dimensions where all the elements to be selected appear simultaneously on the helix, it is possible to point at and to select directly, without changing representation, by means of a cursor for example, any element present on the helix, unlike in the system of the aforesaid American application where only the elements of one turn appear and where it is necessary to modify the representation of the helix to point at the element to be selected.

In certain circumstances, in particular when the number of elements is large, it may be desirable to be able to modify characteristics of the helix in such a way as, for example, to allow easier pointing at elements which are made difficult to access on account of their position on the helix, in particular by masking by other elements situated in the foreground, or on account of a high density of elements on the turns of the helix.

This is why the invention makes provision for said system to comprise a device for manipulating the helix, able to modify at least locally the pitch of the helix. It will be seen further on that this arrangement can have multiple applications, in particular it makes possible a “zoom” or “magnifying glass” effect on the elements to be selected when the latter are very numerous and therefore too close together to be able to be pointed at easily by the cursor. In this case, the pitch of the helix is modified around the element pointed at by the pointing/selection device.

A modification of the pitch of the helix is also implemented when the system according to the invention is able to deploy on the helix sub-elements of an element selected by the pointing/selection device. This tree deployment requires of course a reduction in the pitch of the helix and may be accompanied by a “zoom” or “magnifying glass” effect on the tree thus deployed.

According to one embodiment, said manipulation device is able to pivot the helix about its axis. This characteristic is particularly advantageous so as to bring to the foreground an element that it is desired to point at and select though it was initially in the background and therefore difficult to access in particular by means of a cursor of the pointing/selection device.

The invention also provides for the manipulation device to be able to modify the radius of the helix. In particular, the manipulation device is able to modify the surface area occupied by the helix on the screen. The user can at one and the same time reduce the radius of the helix and its length by shortening the pitch thereof. This affords him means for making the helix more discreet on the screen when it is not used and while its presence would be prejudicial to the application in progress, a collaborative teleconference for example.

The pointing/selection device consists, generally, of a computer peripheral making it possible to displace a cursor indicating the spot where the user can act on the screen. Preferably, said pointing/selection device is an isotonic device. This may be, for example, a 3D pointer, of the type of that available commercially under the brand name “Owl”.

A 2D pointing peripheral can also be used, such as a 2D “mouse”, on condition that it is associated with a mode of interaction making it possible to access the 3^{rd} dimension. In this case, the mouse serves for example to move the cursor in the plane of the screen while an action on a complementary means makes it possible to perform a movement of the cursor depth-wise on an element situated in the background. This complementary means is for example a button or the thumbwheel of the mouse, a key of the keyboard, etc. Depth-wise excursion can be assisted by rendering the elements partially transparent or by automatic projection of the cursor depth-wise.

An element pointed at is selected in particular by means of a facility associated with the mouse by clicking on a button, by tapping a key of the keyboard, or by voice control.

A 2D mouse can also be used as device for manipulating the helix, associated for example with the thumbwheel of the mouse so as to rotate the helix or with an interactive element (“widget”) present on the screen and on which it is possible to click by means of the cursor so as to modify the pitch thereof.

Provision may also be made for said manipulation device to be an isometric device of “control ball” (“3D trackball”) type. The “Space Mouse”, marketed by the company 3Dconnexion, will be cited.

The invention also relates to a method for selecting elements displayed on a screen, said elements being arranged along a helix, noteworthy in that said method comprises steps consisting in:

representing said helix in three dimensions on said screen,

providing a pointing/selection device for pointing at/selecting any element to be selected on the helix and a device for manipulating the helix, able to modify at least locally the pitch of the helix,

selecting, by means of said pointing/selection system, an element to be selected on the helix.

Finally, the invention relates to a computer program comprising program code instructions for executing the method according to the invention when said program is executed on a computer.

The description which follows in conjunction with the appended drawings, given by way of nonlimiting examples, will clarify the nature of the invention and the manner in which it may be carried out.

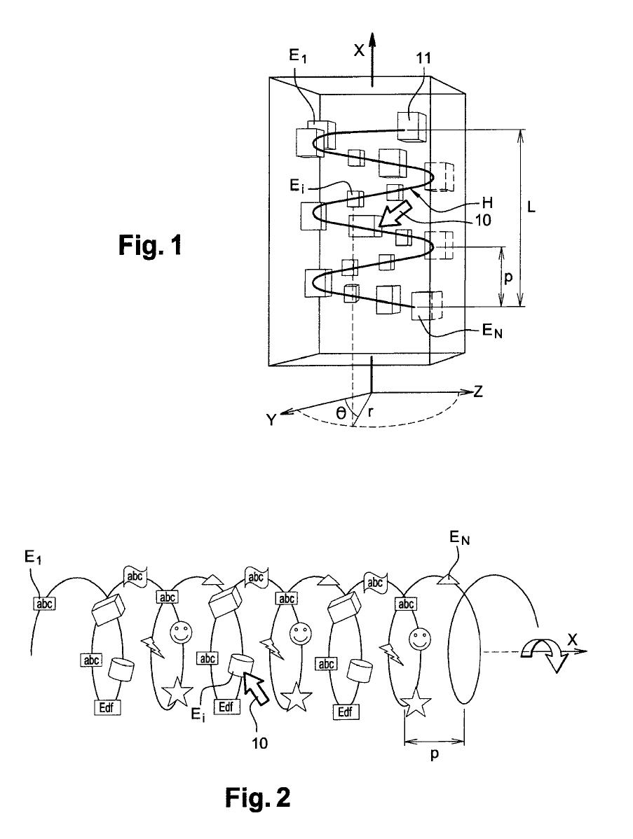

FIG. 1 is a perspective view of a selection system in accordance with the invention.

FIG. 2 is an in-plane view illustrating the selection of an element of the helix.

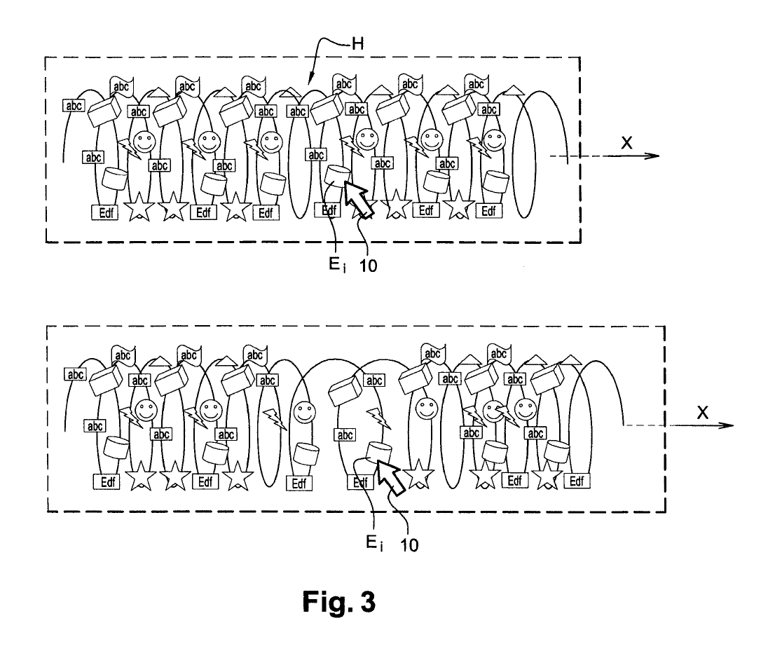

FIG. 3 is an in-plane view illustrating the enlargement of a portion of the helix.

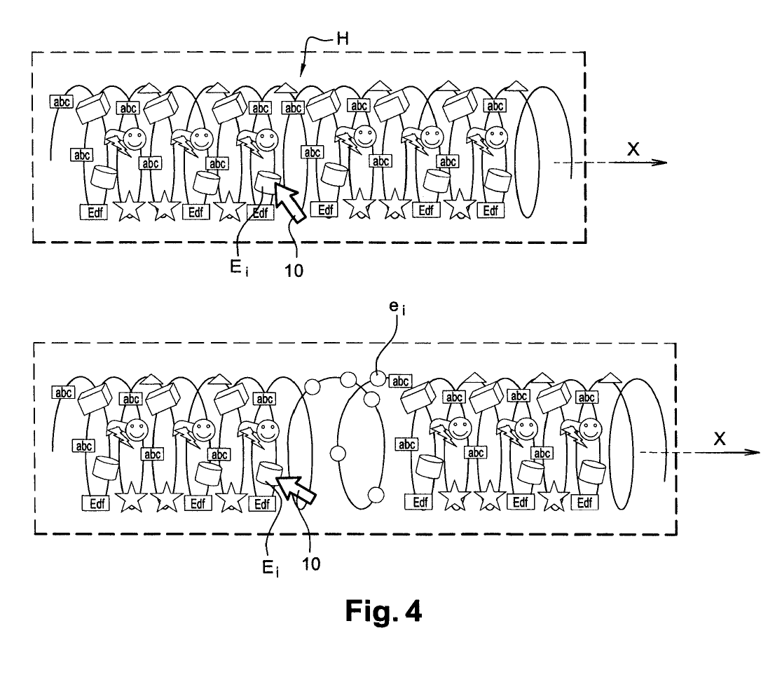

FIG. 4 is an in-plane view illustrating a tree deployment.

In FIG. 1 are illustrated a system and a method for selecting N elements E₁, . . . , Eᵢ, . . . , E_{N} displayed on a screen. These elements belong to a list of objects or of data, such as the items of a menu, and can be represented equally well by icons symbolizing a text, 2D images, objects or hierarchical elements, etc.

The N elements considered are arranged along a helix H represented on the screen according to a 3D scene. The axis of this helix, that is to say the line about which the helix “rotates” in a 3D reference frame (X, Y, Z), will be denoted by X. The points tracing the helix H are projected onto the (Y, Z) plane orthogonal to the X axis according to an equation of a circle which depends on the angle θ defined about the X axis:

Y=r·sin θ

Z=r·cos θ

and

X=p·θ/2π

p represents the pitch of the helix, i.e. the distance traversed by a point of the helix along the X axis for a complete revolution of a circle, that is to say for one turn. The variable r represents the radius of the helix, that is to say the radius of the circle traced on the plane Y-Z by the projection of the helix.

In the embodiment of FIG. 1, the whole set of elements Eᵢ of the list are arranged linearly on the helix H, the elements being placed in this case at equal distance on the helix. If L denotes the length of the helix, that is to say the menu length occupied on the screen, and n denotes the number of elements per turn, the pitch p is given by the relation:

p=n·L/N

Thus, the pitch p is calculated as a function of the variables L, N and of the number n of elements per turn, the latter being determined so as to obtain sufficient readability of the elements having regard to the size of the icons chosen to represent it. However, the pitch p must remain greater than a minimum value, termed the ergonomic pitch, corresponding to the minimum distance between two turns making it possible to distinguish and interact on two consecutive elements of the list, or menu.

It may be noted in FIG. 1 that the arrangement of the elements on the helix H allows the user to see all the elements on the screen, unlike in the system described in American patent application No. 2005/0044509.

As represented in FIG. 2, it is then very easy to point at any element to be selected with the aid of a cursor 10, controlled by a pointing/selection device: 3D pointer or 2D mouse associated with a depth-wise movement means intended to move the cursor 10 onto the elements situated in the background.

To further assist the positioning of the cursor 10 on an element of the list, the user can pivot the helix H about its axis X by means of a manipulation device, thumbwheel of a 2D mouse or rotation of a control ball (“3D trackball”) for example, so as to bring the element that he wishes to point at into the foreground.

Furthermore, the pointing/selection device has a function for selecting an element pointed at, for example a button of the mouse or any other peripheral. When the cursor 10 is positioned on an element of the list, it is possible for the user to select it by activating this selection function. The user can also activate a multiple selection mode making it possible to simultaneously select several elements of the list, or menu, by using for example the “Ctrl” key of the keyboard.

As a function of the number N of elements of the list, it is possible that the pitch may be reduced to such a point that an overlap between the elements prevents any ergonomic interaction, that is to say interaction suited to the task of selecting the elements.

When the pitch of the helix turns out to be too small, the user has a means of increasing it locally, over a small number of turns around the element pointed at, by implementing the “zoom” or “magnifying glass” effect illustrated in FIG. 3, so as to assist the interaction with one of the elements of the list by choosing a pitch at least equal to the ergonomic pitch. To maintain a constant occupancy of the area of the screen, that is to say to keep the length L constant, the local increase in the pitch of the helix can be compensated for through a corresponding decrease uniformly distributed over the other turns of the helix, as shown by FIG. 3.

This operation of enlarging the pitch can be performed by means of the manipulation device, control ball or 2D mouse associated with a peripheral, thumbwheel, key of the keyboard, etc.

The system, which is the subject of the invention, also provides for automatic enlargement of the pitch of the helix to the value of the ergonomic pitch on the basis of the simple positioning of the cursor 10 on the element pointed at.

A list of elements, or menu, may be hierarchical, in the sense that one and the same element can represent a sub-list, or sub-menu. In this case, when the user selects such an element, the elements of this sub-list, or sub-elements eᵢ, are deployed on the helix in the same guise as the elements themselves, as illustrated in FIG. 4. Accordingly, a sufficient number of turns for supporting the new elements are inserted into the helix at the spot where the selected hierarchical element was situated, by using the pitch modification procedure described with reference to FIG. 3. The size of the pitches of the pre-existing list and of the new list is then recalculated so that the screen area occupied remains constant. A different pitch size can be used to differentiate the hierarchical levels of the lists and sub-lists.

The system in accordance with the invention makes it possible furthermore to modify the area occupied on the screen by the helical 3D menu by modifying the length L and the radius r of the helix.

This modification can be ensured by means of the pointing/selection device or of the manipulation device.

A solution for implementing the display area modification function using the pointing/selection device, consists in integrating into the representation of the helix an interactive element (“widget”) 11 (FIG. 1) dedicated to this interaction. It then suffices to select this interactive element in order to access the modification function.

This same function can be carried out by means of the manipulation device, for example the arrows of the keyboard or an axis of translation of the control ball (“trackball 3D”).

The modification of the width, or radius, gives rise to a proportional redimensioning of the representation of the elements of the list. For example, dividing the width by two gives rise to a halving of the size of the elements.

The modification of the length gives rise to a modification of the pitch of the helix proportionately to the modification of the length.

To summarize, the invention exhibits a large number of advantages:

fast access to all the elements by combining 3D pointing/selection with rotations of the helix and/or the modification of its pitch.

adaptation of the surface area occupied by the helix on the screen by simple deformation of its pitch, thereby making it possible for example to minimize the size of the menu when it is not used.

visibility over the whole set of elements allowing multiple selection.

adaptability to the various types of interaction devices, such as touch screens, PDAs, etc.

1. A system for selecting elements displayed on a screen, said elements being arranged along a helix, wherein
said helix is represented in three dimensions on said screen, and
said selection system comprises a pointing/selection device for pointing at/selecting any element to be selected on the helix and a device for manipulating the helix to modify at least locally the pitch of the helix.

2. A system according to claim 1, in which said manipulation device pivots the helix about its axis.

3. A system according to claim 1, in which the pitch of the helix is modified around the element pointed at by the pointing/selection device.

4. A system according to claim 3, in which the pitch of the helix is modified automatically merely on pointing at said element.

5. A system according to claim 1, in which the pitch of the helix is brought to a minimum pitch value, termed the ergonomic pitch.

6. A system according to claim 1, in which said system is able to deploy on the helix sub-elements of an element selected by the pointing/selection device.

7. A system according to claim 1, in which said pointing/selection device is able to select a plurality of elements on the helix.

8. A system according to claim 1, in which the manipulation device is able to modify the radius of the helix.

9. A system according to claim 8, in which the manipulation device is able to modify the surface area occupied by the helix on the screen.

10. A system according to claim 1, in which said pointing/selection device is an isotonic device.

11. A system according to claim 1, in which said manipulation device is an isometric device.

12. A method for selecting elements displayed on a screen, said elements being arranged along a helix, said method comprising the steps:
arranging a plurality of elements along a helix;
displaying said helix in three dimensions on said screen,
providing a pointing/selection device for pointing at/selecting any element on the helix, and providing a device for manipulating the helix to modify at least locally the pitch of the helix,
selecting, by means of said pointing/selection device, an element on the helix.

13. A computer program comprising program code instructions for executing the method according to claim 12 when said program is executed on a computer.
